(19) United States
(12) Patent Application Publication
(10) Pub. No.: US 2015/0145351 A1
(43) Pub. Date: May 28, 2015

(54) METHOD FOR POTTING A STATOR

(71) Applicant: MOTEURS LEROY-SOMER, ANGOULEME (FR)

(72) Inventors: Sébastien Porcher, St Palais (FR); Haikel Gherairi, Charatonnay (FR); Stéphane Dufau, Angouleme (FR)

(73) Assignee: MOTEURS LEROY-SOMER, ANGOULEME (FR)

(21) Appl. No.: 14/397,271

(22) PCT Filed: Apr. 26, 2013
(86) PCT No.: PCT/IB2013/053327

§ 371 Date: Oct. 27, 2014

(30) Foreign Application Priority Data
Apr. 27, 2012 (FR) 1253955

(51) Int. Cl. H02K 15/10; H02K 3/44

(52) U.S. Cl. CPC H02K 15/10; H02K 3/44
USPC 310/43; 264/272.2; 425/500

(57) ABSTRACT

The present invention relates to a method for potting a stator of an electric machine, including:—introducing an expandable, preferably elastically deformable, non-metallic shell in a non-expanded state into the stator,—expanding the shell,—pouring a resin around the shell, inside the stator,—retracting and removing the shell after the resin has set.

The present invention relates to the manufacture of electric machines, and more particularly, stators.

It is known practice to impregnate the stator with a resin. This is applied to the magnetic frame and the winding in the form of a coating.

Potting is distinguished from impregnation by a step of filling the dead volume defined between a mandrel arranged temporarily in the central bore of the stator and an outer shell which can be defined by the casing of the stator, the frame or otherwise.

The potting makes it possible to reduce the overheating of the machine by replacing the air present in the stator with resin, which conducts heat, and thus increase the specific power of the machine. The potting also makes it possible, when the machine is a motor, to increase the strength at the maximum torque of the motor. The potting also contributes to improving the quality of insulation of the stator, its resistance to environmental stresses and makes it possible to increase the rigidity of its structure.

Currently, the mandrel used is made of polyethylene. The potting method comprises the introduction of the mandrel cold into the stator, then the assembly is heated so as to expand the mandrel before the introduction of the resin. To strip the stator from the mold, the latter is cooled; the shrinkage of the mandrel on cooling generates the gap required for the mold-stripping operation. The mandrel bears residues of resin after the mold-stripping operation, which necessitates a relatively lengthy cleaning operation. Furthermore, since the mandrel has a machined outer surface, the surface condition of the resin is not smooth. Since the gap is small when the mandrel is introduced, its placement is difficult.

The application US 2005/0074548 is known, which describes electric motor encapsulation methods. This application describes the use of a double cone to produce the expansion of a shell. However, this type of method may not make it possible to satisfactorily control the expansion, may lead to the appearance of gaps and to premature wear of the shell.

The application EP 0 321 582, which describes stator coating methods, is known.

The patent GB 976 909, which describes stator encapsulation methods, is known.

The U.S. Pat. No. 4,015,154, which describes stator manufacturing methods, is known.

Also, the U.S. Pat. No. 1,875,206, which describes stators coated with a layer of glass, is known.

The invention aims to further refine the methods for potting stators of electric machines, notably in order to reduce the duration of the operation and the material cost, and it achieves this by virtue of a method for potting a stator of an electric machine comprising the steps consisting in:
introducing an expandable, preferably elastically deformable, non-metallic shell in a non-expanded state into the stator,
causing the shell to expand,
pouring a resin around the shell, inside the stator,
retracting and removing the shell after the resin has set.

“Non-expanded state” should be understood to mean a state that is less expanded than that during the pouring of the resin.

By virtue of the invention, the duration of the potting operation is considerably shortened. The placement of the shell is also simplified, because a relatively large gap can be formed at the time of the introduction of the shell into the stator.

The expansion of the shell is preferably caused by an expansion tool arranged inside the latter. This expansion tool can be deformed by a mechanical action, for example a wedge effect.

Preferably, the expansion tool is configured to convert a tightening torque into an expansion of the shell.

One such type of expansion tool is advantageous in as much as it makes it possible, compared to the double cone of US 2005/0074548, to better control the expansion and to limit the gap produced. This makes it possible to avoid the formation of thin films of resin which can peel off and damage the correct operation of the electric machine.

This expansion tool can comprise a tightening screw and a mandrel interacting with two abutments, the separation of which is modified by the tightening screw. The convergence of the abutments can be accompanied by a radial expansion of the mandrel, and therefore of the shell which surrounds it. The mandrel can comprise segments, one in every two of which are linked at one end. The abutments can have respective conic tapered surfaces converging toward one another.

The use of a shell made of an elastically deformable synthetic material is preferred, because it renders the latter insensitive to scratching or impacts and offers a good control of the dimensions of the block of potting resin that has hardened, by virtue of the possibility of accurately controlling its expansion; furthermore, it leads to a low rate of rejection of consumable material and to a very good surface quality. Preferably, the shell comprises or is made of silicone, of rubber or of polyurethane.

The invention makes it possible, notably by using an expansion tool as defined above, to obtain a resin potting in which the inner diameter exhibits a low, controlled dispersion, for example less than or equal to 0.2 mm, along the bore of the stator.

The volume for receiving the resin, defined between the shell and the stator, is preferably closed at the bottom by a blocking plate.

The method can comprise the fitting onto the stator of at least one plug for blocking a passage of wires. This blocking plug, like the blocking plate, can be made of the same material as the shell, notably of an elastically deformable material such as silicone.

The blocking plug can comprise a slot or holes for the passage of the wires. The outer surface of the shell advantageously has a roughness Rₐ (arithmetic mean deviation) less than or equal to 5 μm, or better, 3 μm, the shell preferably being obtained by casting or compression.

Such roughness values make it possible to obtain a stator of good quality and with an increased life, by notably preventing thin films of resin from peeling off during the operation of the machine and damaging the latter.

It is, moreover, advantageous for the shell to be obtained by compression in as much as this makes it possible to more easily obtain a shell of low roughness.

A shell achieved by compression can be produced by cross-linking under pressure. Such a method advantageously makes it possible to reduce the cavities obtained on the surface of the shell and therefore obtain the desired low roughness.

In the method according to the invention, the resin is poured around the shell, inside the stator, while the shell is in an expanded state.

Advantageously, the resin is poured over the entire height of the stator.

At least one inscription can be made by molding on the resin, notably using a relief inscription present on a blocking plate and/or the blocking plug arranged at the passage for the wires to the terminal box of the machine. The shell is advantageously first retracted and then removed after the resin has set.

Another subject of the invention, according to another of its aspects, is an installation for implementing the method according to the invention, this installation comprising:
an expandable, preferably elastically deformable, non-metallic shell,
a tool for expanding the shell, which can be metallic or not,
preferably a plate for blocking the stator at one end, and
preferably, at least one plug for blocking a wire passage opening from the winding to a terminal box of the machine.

The expansion tool is advantageously as defined above.

Another subject of the invention is a stator of an electric machine, comprising:
a magnetic frame comprising teeth separated by notches,
a winding arranged in the notches of the magnetic frame,
a central passage for the rotor, defined by the teeth and by a resin potting, the roughness Rₐ of the radially inner surface of the resin potting, between the teeth, being less than or equal to 5 μm, or better, 3 μm.

Such a roughness is characteristic of the implementation of the method with a shell whose radially outer surface is smooth, notably a shell obtained from casting or compression.

Preferably, the radially inner surface of the potting extends set back from the teeth, between the latter. This is characteristic also of the use of an elastically deformable shell which is pressed against the teeth before the introduction of the fluid resin into the stator.

The potting can comprise relief inscriptions, notably at an axial end of the stator and at the passage for the wires to the terminal box.

These inscriptions are advantageously made using the blocking plate and/or the blocking plug as defined above.

The invention will be able to be better understood on reading the following detailed description of non-limiting exemplary implementations thereof, and on studying the attached drawing, in which:

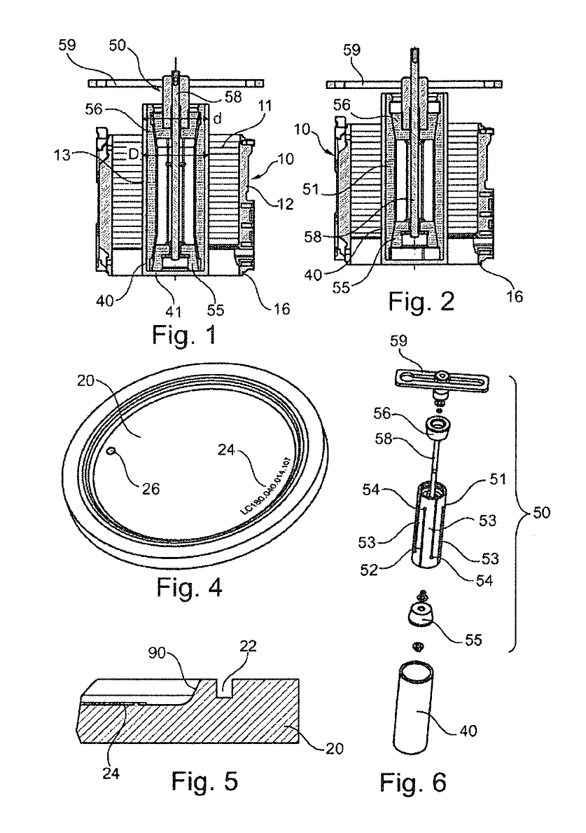

FIG. 1 schematically represents, in partial axial cross section, an example of an electric machine stator intended to be potted with a resin,

FIG. 2 is a view similar to FIG. 1, after expansion of the shell arranged in the central bore of the stator,

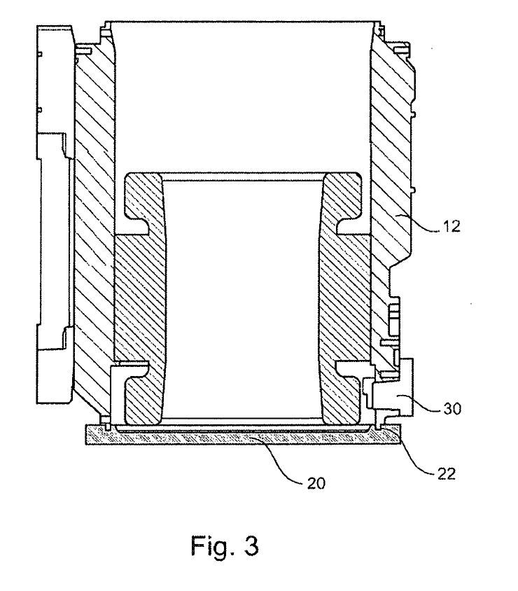

FIG. 3 illustrates the closure of the stator by a blocking plate and blocking plug,

FIG. 4 represents, on its own, in perspective, the blocking plate,

FIG. 5 represents, in axial cross section, a detail of production of the blocking plate,

FIG. 6 is an exploded view of the shell and of the tool used to cause its expansion inside the stator,

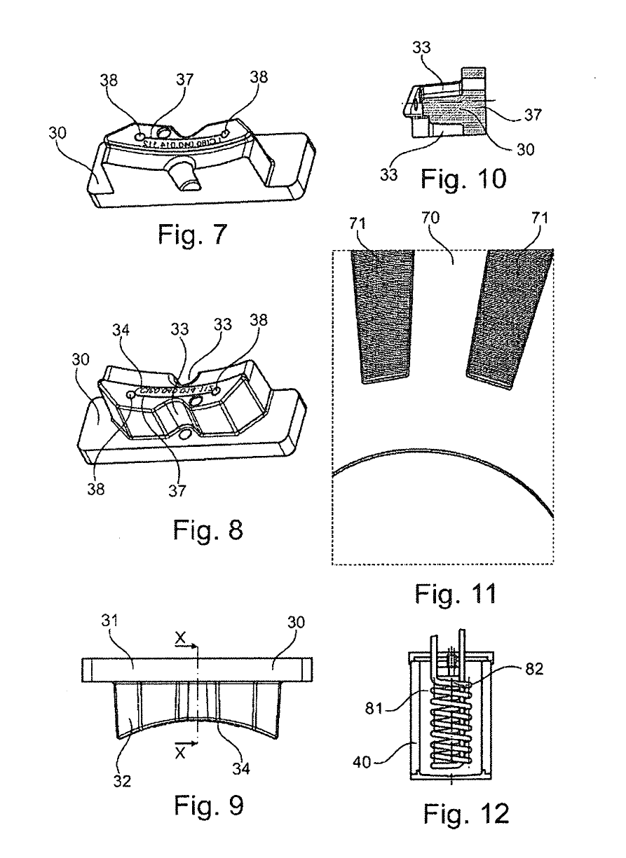

FIGS. 7 and 8 are perspective views, from different directions of observation, of the blocking plug,

FIG. 9 is a side view of the blocking plug of FIGS. 7 and 8,

FIG. 10 is a section along X-X of FIG. 9,

FIG. 11 represents, schematically and partially, the central bore of the stator, after potting, and

FIG. 12 represents an expansion tool embodiment.

FIGS. 1 and 2 represent an electric machine stator 10, comprising a magnetic frame 11 formed, in the example considered, by a stack of magnetic plates. These plates are, for example, cut separately and superposed or cut in the form of segments linked together then wound round an axis to form the frame.

The frame 11 comprises teeth directed toward the air gap, defining between them the notches receiving the winding of the machine, which cannot be seen. The winding is, for example, concentrated or distributed.

The frame 11 is arranged in a casing 12, for example obtained by aluminum casting. This casing 12 may accommodate, on the outside, a terminal box which is not represented, which serves to connect the wires of the winding with an electronic module or a power supply cable.

In order to proceed with the operation of pouring the resin into the stator, a blocking plate 20 is arranged under the stator, as illustrated in FIG. 3, to close it at the bottom.

A blocking plug 30 is also arranged on the casing 12 to close a side opening for the passage of wires from the winding to the terminal box, while allowing a wire bundle to pass through.

The casing 12 may have, at its bottom end, an annular bead 16, and the blocking plate 20 may have a corresponding annular groove 22, to be fitted into the bead 16, as illustrated in FIG. 3.

The blocking plate 20 is, for example, made from an elastomer material, such as a silicone. A relief inscription 24 in inverted writing can be made on the top face of the plate 20, so as to produce a corresponding indented inscription on the resin poured inside the stator. Preferably, the blocking plate has a slope 90 toward the bead which radially inwardly delimits the groove 22, preferably of between 20 and 30°, for example 25°, to facilitate the mold-stripping operation and avoid premature wear at the risk of leaving a piece of the plate on each stator and therefore also reducing its function to very few moldings.

The blocking plate 20 can comprise a position making it possible to inscribe a plate manufacturing date, this hole 26 being, for example, situated diametrically opposite the inscription 24.

An elastically deformable shell 40, also called skin, is arranged in the central bore of the stator, this shell 40 being mounted on an expansion tool 50, represented on its own in FIG. 6.

The shell 40 is, for example, as illustrated, of a substantially constant thickness over its entire height and it is closed at its bottom end by a bottom 41. The outer lateral surface of the shell 40 is a right circular cylinder, with an axis that is merged with the axis of rotation of the machine, of relaxed diameter d less than the diameter D of the central bore of the magnetic frame 11 of the stator. As a variant, the potting has a variable thickness.

The radial gap j that exists with the frame 11, namely (D−d)/2, is for example greater than or equal to 1 mm, or better 1.5 mm, even 4 or 5 mm.

For a diameter d, the gap j represents, for example, at least 1.5 10⁻³ d.

The thickness of the shell 40, in its cylindrical part, is for example between 2 and 20 mm, being constant or variable.

The shell 40 is preferably made of silicone, of rubber or of polyurethane.

The expansion tool 50 comprises a mandrel 51 also called socket, for example made of PTFE, comprising longitudinal slots 52 defining segments 53, one in every two of which are linked at one end. Thus, a given segment 53 is linked to one of the adjacent segments by its top end and to the other adjacent segment by its bottom end. Holes 54 can be produced at the end of the slots 52 to avoid creating incipient tears when the segments 53 are separated. Each slot 52 extends from the hole 54 to the opposite edge of the mandrel. The number of segments is preferably greater than or equal to 2. The number of segments is defined as a function of the elasticity of the mandrel that is desired and of the expansion coefficient and the nature of the shell.

As a variant, the mandrel is made of metal.

The tool 50 comprises two moving abutments 55 and 56, having conic tapered surfaces converging toward one another.

The mandrel 51 is produced with an inner profile adapted to cooperate with the abutments 55 and 56. The mandrel 51 can thus be produced with, on its inner surface, slopes with the same taper as the abutments 55 and 56, as illustrated in FIG. 1.

A screw 58 links the abutments 55 and 56 and makes it possible to bring them toward one another or to separate them depending on the direction in which a wrench 59, intended to be driven in rotation by an operator, is turned. The wrench actuates a nut fitted onto the screw 58, secured to the top abutment. Washers ensure the axial immobilization of the bottom abutment 55 relative to the screw 58 and limit the downward travel of the top abutment 56.

The blocking plug 30 is preferably molded in silicone (but can also be made from the same ranges of materials as described previously), and comprises a base 31 extended by an end-fitting 32 intended to be fitted into a corresponding opening of the casing 12. The end-fitting 32 comprises a slot 37 for the passage of the wires of the winding. This slot 37 emerges at its ends on holes 38 which avoid creating an incipient tear.

The end-fitting 32 can include voids 33 on either side of the slot 37. These voids are matched to the geometry of the casing and make it possible to limit the quantity of material in the plug.

The end-fitting 32 can also include, as illustrated, on its radially inner face, a relief inscription 34, in negative writing, intended to show information in positive writing when stripped from the mold.

When the shell 40, arranged on the mandrel 51, is introduced inside the stator, its outer diameter d is significantly less than the diameter D of the central bore of the magnetic frame 11, which simplifies the placement of the shell 40 without damaging it.

The abutments 55 and 56 are then brought closer to one another to expand the shell 40 radially outward, under the effect of the radial expansion of the mandrel 51. The segments 53 each exert a thrust directed radially outward on the shell 40.

The shell 40 is pressed against the radially inner surface of the teeth 71 of the frame 11, visible in FIG. 11, and lightly compressed against the latter. Preferably, the resin is poured when the stator has been preheated. The heating of the stator, of the shell 40 and of the expansion tool further enhances, by thermal expansion, the contact between the shell 40 and the teeth 71. The heating of the stator can also improve the wetability of the winding with the resin.

A volume for receiving the resin is defined around the shell 40, being closed at the bottom by the blocking plate 20 and laterally by the blocking plug 30.

The outer surface of the shell 40 has a roughness Rₐ less than or equal to 5 μm, or better, 3 μm, the shell preferably being obtained by casting or compression.

The resin is poured hot, the stator preferably being placed in a vacuum bell which facilitates the evacuation of the air bubbles contained in the resin. The temperature of the resin is, for example, greater than or equal to 60° C. The resin is, for example, a two-component epoxy resin.

The resin polymerizes and extends, after hardening, in the form of a potting 70 between the teeth 71 of the magnetic frame 11, as can be seen in FIG. 11.

To extract the shell 40, the operator acts on the screw 58 to move the abutments 55 and 56 apart and provoke the retraction of the mandrel 51. By virtue of its elasticity, the shell 40 accompanies the retraction of the mandrel 51. The surface state of the resin in the central bore of the stator is smooth, with a roughness Rₐ less than or equal to 5, or better, 3 μm, for example close to 2 μm (microns). In particular, the surface of the resin is without any traces of machining, unlike the surface obtained in the use of a machined metal or plastic mandrel, with the resin being poured in contact therewith.

The surface of the resin, between the teeth 71, is situated radially slightly set back from the teeth 71, preferably by more than 1 mm, even 1.5 mm, for example by approximately 1.8 mm. This is due to the deformability of the shell 40 which may have been compressed against the teeth 71 by the mandrel 51, while penetrating slightly into the notches formed between the teeth 71, normally without touching the winding unless this is sought.

The invention is not limited to the illustrated example.

Thus, the expansion tools other than that which has been described can be used. For example, the displacement of the abutments which act on the mandrel can be caused by an actuator other than a screw, for example a pneumatic or hydraulic cylinder. The shell can also be subjected to the pressure of a gas or of a liquid, contained for example in a bladder arranged inside the mandrel or directly in contact with the shell. The shell can also be subjected directly to the pressure of a gas or of a liquid, but this makes it more difficult to control its expansion and generates a risk of the shell contacting the winding, which is not desirable.

The shell can also be subjected to the heat expansion force of a mandrel, metal or not, provided with a heating or cooling circuit specific to it. For example, the expansion tool comprises a coil which is passed through by a cooling or heating gas or liquid, this coil being arranged within a mandrel comprising a block of material molded with the shell or onto which the shell is added. The coil provides a fast way of cooling and retracting the shell.

As an example, FIG. 12 shows a variant expansion tool comprising a body 81, for example of aluminum, passed through by a coil 82 in which a fluid circulates, so as to be able to undergo fast cooling. The shell 40 is arranged around the body 81.

The latter can expand under the effect of the heat and provoke the expansion of the shell 40. After the resin has hardened, the body 81 can be cooled rapidly by virtue of the coil, which reduces its diameter and allows for the mold-stripping.

In a variant, the stator comprises a magnetic frame without casing.

The expression “comprising a” is synonymous with “comprising at least one”.

1-16. (canceled)

17. A method for potting a stator of an electric machine, comprising the steps consisting in:
introducing an expandable, non-metallic shell in a non-expanded state into the stator,
causing the shell to expand,
pouring a resin around the shell, inside the stator,
retracting and removing the shell after the resin has set, the outer surface of the shell having a roughness less than or equal to 5 μm.

18. The method according to claim 17, the shell being made of an elastically deformable synthetic material.

19. The method according to claim 18, the shell comprising or being made of silicone, of rubber or of polyurethane.

20. The method according to claim 17, the expansion of the shell being caused by an expansion tool arranged inside the latter.

21. The method according to claim 20, the expansion tool being configured to convert a tightening torque into an expansion of the shell.

22. The method according to claim 21, the expansion tool comprising a tightening screw and a mandrel co-operating with two abutments, the separation of which is modified by the tightening screw.

23. The method according to claim 22, the mandrel comprising segments, one in every two of which are linked at one end.

24. The method according to claim 20, the expansion tool comprising a body passed through by a coil in which a fluid circulates.

25. The method according to claim 17, a volume for receiving the resin, defined between the shell and the stator, being closed at the bottom by a blocking plate.

26. The method according to claim 17, comprising the fitting onto the stator of at least one plug for blocking any passage of wires.

27. The method according to claim 17, the outer surface of the shell having a roughness less than or equal to 3 μm.

28. The method according to claim 17, the shell being obtained by compression.

29. The method according to claim 17, at least one inscription being made by molding on the resin, notably using a relief inscription present on a blocking plate or a blocking plug arranged at a wire passage to a terminal box of the machine.

30. An installation for implementing the method as defined in claim 17, this installation comprising:
an expandable, elastically deformable, non-metallic shell,
a tool for expanding the shell.

31. The installation according to claim 30, the tool being an expandable mandrel.

32. The installation according to claim 30, the installation comprising a plate for blocking the stator at one end.

33. The installation according to claim 30, the installation comprising at least one plug for blocking a wire passage opening from the winding to a terminal box of the machine.

34. A stator of an electric machine, notably obtained by implementing the method as claimed in claim 17, comprising:
a magnetic frame comprising teeth separated by notches,
a winding arranged in the notches of the magnetic frame,
a central passage for the rotor, defined by the teeth and by a resin potting, the roughness of the radially inner surface of the resin, between the teeth, being less than or equal to 5 μm, or better, 3 μm.

35. The stator according to claim 34, the radially inner surface of the resin potting extending set back from the teeth.

36. The stator according to claim 34, the radially inner surface of the resin potting being without any traces of machining.
